(19) United States
(12) Patent Application Publication
(10) Pub. No.: US 2008/0134517 A1
(43) Pub. Date: Jun. 12, 2008

(54) Pizza cutting and serving device

(75) Inventors: Cheri Bosworth, Prescott, AZ (US); Sean Manross, Prescott, AZ (US)

Correspondence Address: ETHERTON LAW GROUP, LLC, 5555 E. VAN BUREN STREET, SUITE 100, PHOENIX, AZ, 85008, US

(73) Assignee: Kiss S&C, Inc.

(21) Appl. No.: 11/999,470

(22) Filed: Dec. 5, 2007

Related U.S. Application Data
(60) Provisional application No. 60/873,091, filed on Dec. 7, 2006.

(51) Int. Cl. A21C 15/04; B26B 13/22

(52) U.S. Cl. 30/114; 30/194

(57) ABSTRACT

A cutting and serving device for pizza and similarly-shaped foods allows a user to cut a pizza into slices and serve the slices with one hand. Scissors cut the crust and toppings of the pizza and a spatula-like serving surface, projecting outward from the scissors, slides under and supports the cut slices. In the preferred embodiment, the serving surface extends vertically from the pizza. Alternatively, the serving surface extends horizontally from the scissors and is inserted under the pizza to receive the slice when it is cut. Preferably, the scissor blades and serving surface are coated with a non-stick clear polymer. The scissor blades may be held together by a swivel pin or by a hinge. The device may be collapsible for easy storage.

### CROSS-REFERENCE TO RELATED APPLICATIONS

This application claims the benefit of co-pending provisional application No. 60/873,091 filed Dec. 7, 2006.

### FIELD OF INVENTION

This invention relates to food preparation devices. This invention relates particularly to an apparatus for cutting a pizza or other food into slices and serving the slices.

### BACKGROUND

In order to serve a portion of a pizza, pie, or other food that is cooked as a single unit, it is generally necessary to cut the food into slices sized for an individual. Specialized pizza-cutting tools have been devised to accomplish the slicing. The most common pizza cutter is the pizza wheel, a substantially flat disc of metal with a sharp outer edge, attached at its center to a handle. A user rolls the pizza wheel back and forth across the pizza, using varying amounts of pressure to cut the pizza, which typically varies in thickness.

The design of the pizza wheel causes a significant problem when cutting a pizza: the user cannot determine how the thickness of the pizza will vary, and so will not apply appropriate pressure to cut the pizza. Too little pressure results in the user having to retrace the first pass with a second pass to finish the cut. Too much pressure often damages the surface the pizza is resting on. If the pizza sits on a pizza pan, the pan may need to be replaced. If the pizza sits on a countertop, the cutting edge of the pizza wheel may permanently scar the countertop. Additionally, different pizza toppings may require different amounts of pressure to be cut, and so may “catch” on the pizza wheel and drag across the surface of the pizza, affecting topping distribution and aesthetic presentation of the pizza.

Other pizza-cutting implements attempt to resolve this problem. Pizza cutting scissors manage varying pizza thickness by disposing one blade beneath the pizza and the other above it, so that the user can continually vary pressure as needed. The effect of torque around the swivel pin in a pair of scissors provides increasing cutting power from pin to the tip. If the user encounters a thickness in the pizza, or a stubborn topping, the user can reposition the scissors to put the thicker part near the pin, thereby increasing the cutting power without increasing the pressure. This allows the user to increase cutting pressure without damaging the surface the pizza is resting on.

One drawback common to both the pizza wheel and pizza scissors is the mess often created when pulling the device out and away from the pizza, because the device may drag ingredients with it. In order to serve the slice, the user must either set the device aside and acquire a separate spatula, or use his second hand to insert the spatula under the slice while cutting it. It would be advantageous to include a spatula-like surface on the cutting device to facilitate cutting and serving with one hand and without the need for multiple tools.

Therefore, it is an object of this invention to provide a single tool to cut pizza and other foods into slices and serve them. It is a further object that the tool be usable with one hand. Another object is that the apparatus does not damage the surface the pizza is resting on. Another object of this invention is to improve the cleanliness of the pizza serving area. A further object is to maintain the aesthetic appeal of the pizza once it is cut into slices and served.

### SUMMARY OF THE INVENTION

A cutting and serving device for pizza and similarly-shaped foods allows a user to cut a pizza into slices and serve the slices with one hand. Scissors cut the crust and toppings of the pizza and a spatula-like serving surface, projecting outward from the scissors, slides under and supports the cut slices. Preferably, the scissors include handles that allow the user to easily grip the scissors. Preferably, the scissor blades and serving surface are coated with a non-stick polymer. The scissor blades may be held together by a swivel pin or by a hinge. The device may be collapsible for easy storage.

### BRIEF DESCRIPTION OF THE DRAWINGS

FIG. 1 is a left side view of the preferred embodiment of the present invention.

FIG. 2 is a right side view of the preferred embodiment of the present invention.

FIG. 3 is a top view of the preferred embodiment of the present invention.

FIG. 4a is an elevational view of the preferred embodiment of the present invention cutting a pizza.

FIG. 4b is an elevational view of an alternative embodiment of the present invention cutting a pizza.

FIGS. 5a, 5b, and 5c illustrate cutting a slice of pizza using the preferred embodiment of the present invention.

FIG. 6 is a left side view of an alternative embodiment of the present invention.

FIG. 7 is a right side view of an alternative embodiment of the present invention.

FIG. 8 is a top view of an alternative embodiment of the present invention.

FIG. 9 is a bottom view of an alternative embodiment of the present invention.

FIGS. 10a and 10b illustrate cutting a slice of pizza using an alternative embodiment of the present invention.

### DETAILED DESCRIPTION OF THE INVENTION

The figures illustrate the present invention, designated generally as 10, which is used to cut a pizza or other food into slices and serve the slices. The tool may be used on any food that is amenable to being cut with scissors, such as pizza (round or square), pie, tortillas, spanikopita, and the like. All foods with which the present invention will function are referred to herein as pizza.

A user divides a pizza into slices by cutting the pizza with a pair of scissors similar to those known in the field of handheld cutting implements. Specifically, the scissors comprise a first blade 11, a second blade 13 connected to the first blade 11 at a fulcrum 19, a thumb handle 15, and a finger handle 17. Each blade 11 and 13 has a sharpened cutting edge 12 and 14 which face each other. When the blades 11 and 13 are rotated about the fulcrum 19, they pass in such proximity as to slice a pizza positioned between the opened blades 11 and 13. The blades 11 and 13 are preferably stainless steel but can be any material that can be sharpened to create a cutting edge. Alternative materials include, but are not limited to, other non-toxic metals, plastic, and ceramic. The blades 11 and 13 can be any length suitable to cutting a pizza. In the preferred embodiment, the blades 11 and 13 are 9 inches long so that they reach the center of most pizzas. The fulcrum 19 comprises a mechanism that attaches the second blade 13 to the first blade 11 and permits rotation, such as a swivel pin, screw, or other mechanism known in the art. In the preferred embodiment, the fulcrum includes a stainless steel screw.

The thumb handle 15 includes a thumb aperture 16 through which the user inserts his thumb, and the finger handle 17 includes a finger aperture 18 through which the user inserts one or more fingers. In the preferred embodiment, the finger aperture 18 is large enough to allow the user to insert three fingers to support the cutting motion. The thumb handle 15 and finger handle 17 may be separate pieces that are attached to the first blade 11 and second blade 13, respectively. The handles may be any material suitable to food-handling implements, including polymers such as polyethylene, polypropylene, and rigid polyvinyl chloride. In the preferred embodiment, the handles are separate pieces made of polypropylene. Alternatively, the thumb handle 15 and finger handle 17 may be an integral part of the respective blades 11 and 13 to which they are attached; for example, the first blade 11 and thumb handle 15 may be a single piece of metal.

A projection extends from a cross blade to form a spatula 20. Preferably the spatula 20 is made from the same material as the blade to which it is attached, so that the blade and spatula 20 may be a single piece. Stainless steel is preferred. Alternatively, the spatula 20 may be a different material, such as aluminum, plastic, or ceramic, and attached to the blade either permanently by soldering or adhesive, or temporarily by a hinge or interlocking tab system. The spatula may be any shape that is conducive to supporting the cut piece, such as a square, rectangle, crescent or hemisphere. For foods such as pizzas and pies that are cut into wedges, the spatula is preferably triangular. The spatula 20 of the preferred embodiment includes a leading edge 32 of about the same length as the blade to which the spatula is attached, preferably 9 to 9.5 inches, and a rear edge 33 preferably 4 to 4.5 inches long, creating a triangular surface area as shown in the figures. The spatula 20 may also be coated in a non-stick polymer, preferably PTFE. The spatula 20 may include one or more slots 34 cut through the spatula 20 to allow runoff of liquid or crumbs, as is known in the art.

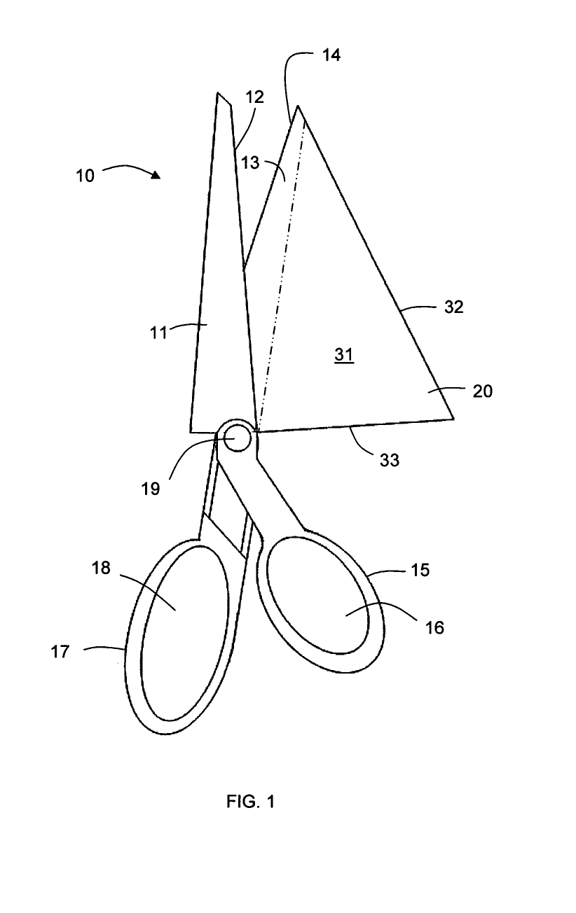

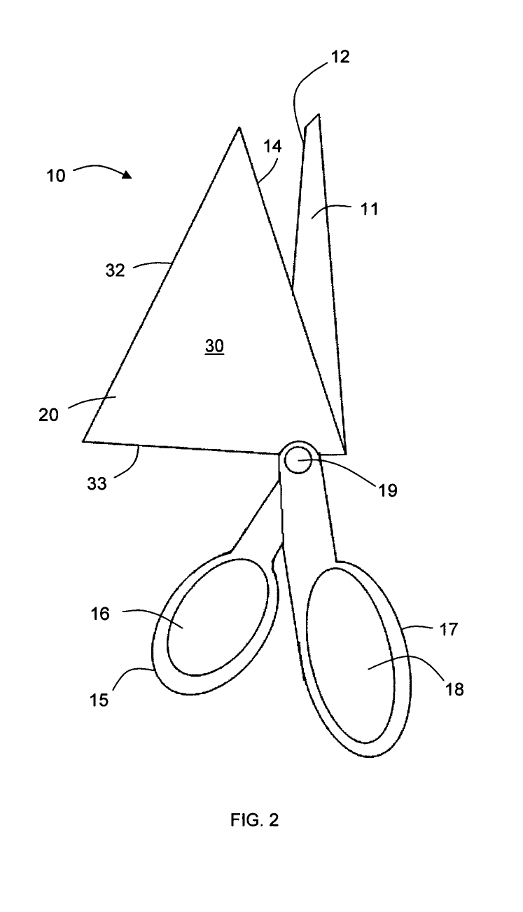

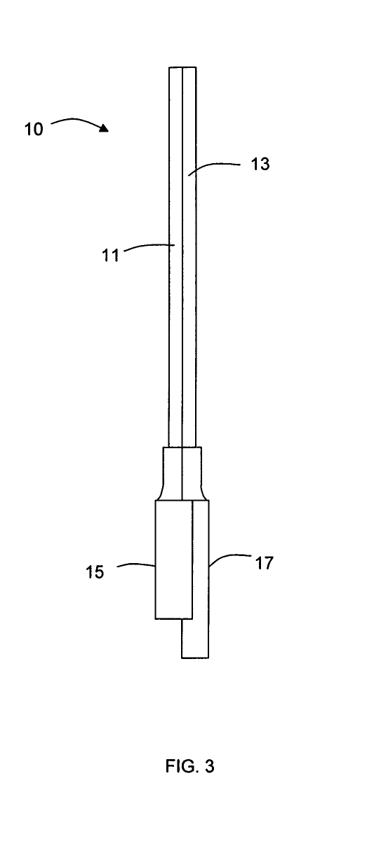

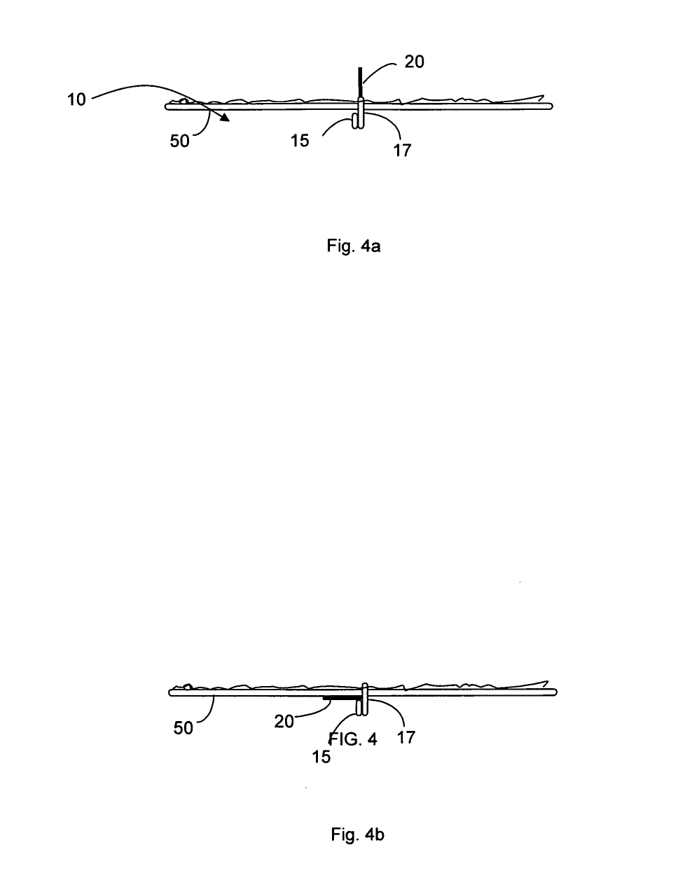

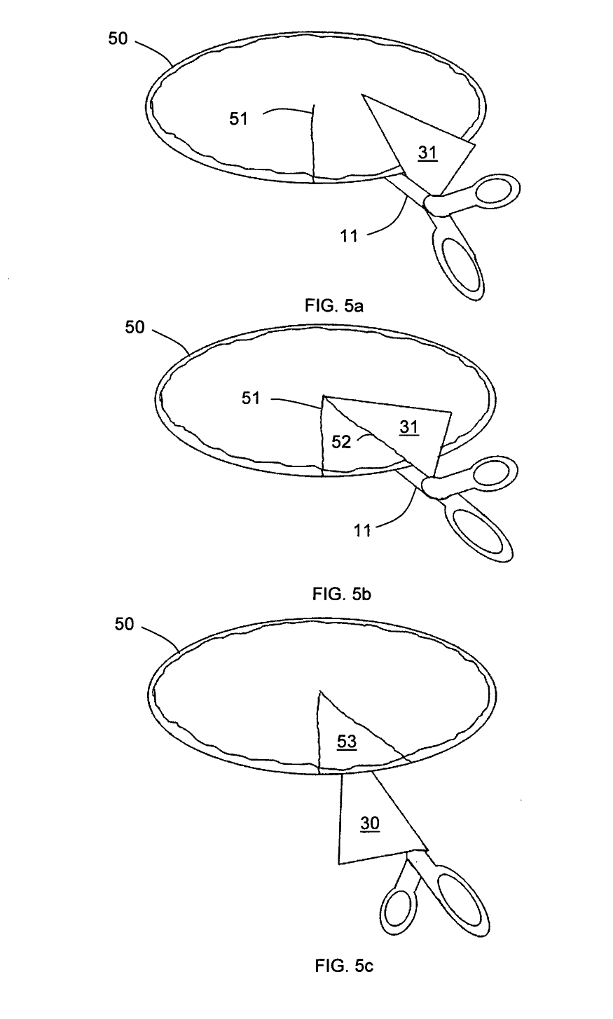

In the preferred embodiment, as shown in FIGS. 1-4a, the spatula 20 extends from the second blade 13 in the same plane. That is, when the apparatus 10 is in position for cutting, the spatula 20 extends from the second blade 13 such that it is substantially perpendicular to the surface on which the pizza sits. See FIG. 4a. The second blade 13 and spatula 20 are a single piece of PTFE-coated stainless steel. As illustrated in FIGS. 4a-4c, to cut and serve a slice of pizza 50, the user inserts the first blade 11 under the pizza 50 and makes a cut to the center of the pizza 50. If it is the first slice from the pizza 50, the user must make a second cut 52 at a distance from the first cut 51, about 4.5 inches in the preferred embodiment, to create a slice 53 that can be efficiently served on the spatula 20. Once the slice 53 is cut, the user removes the first blade 11 from the pizza 50 and inserts the spatula 20 under the slice 53, lifting and serving with the same hand he used to cut.

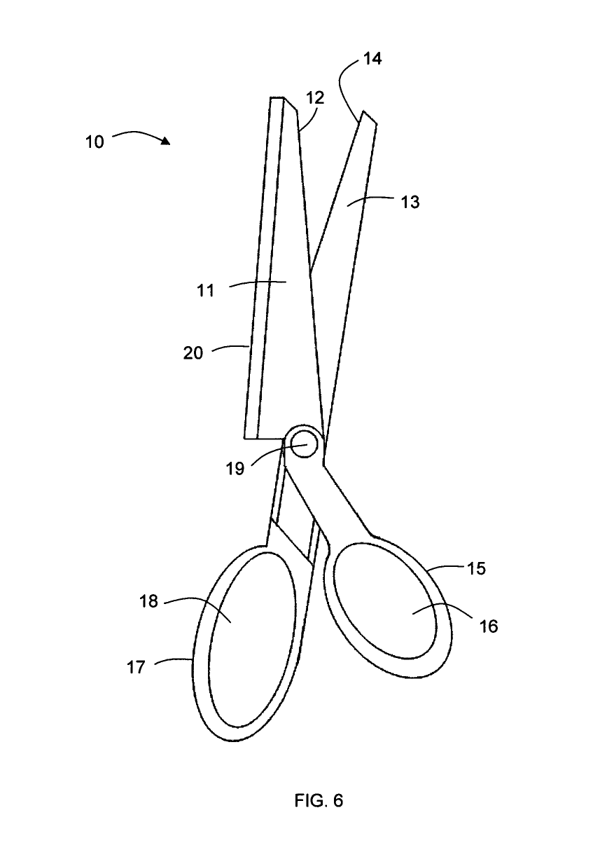

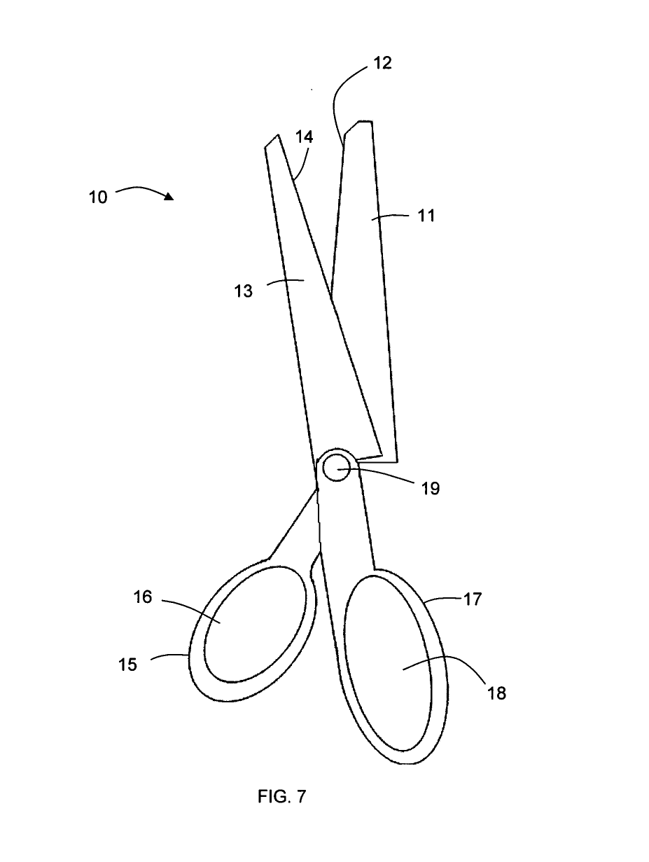

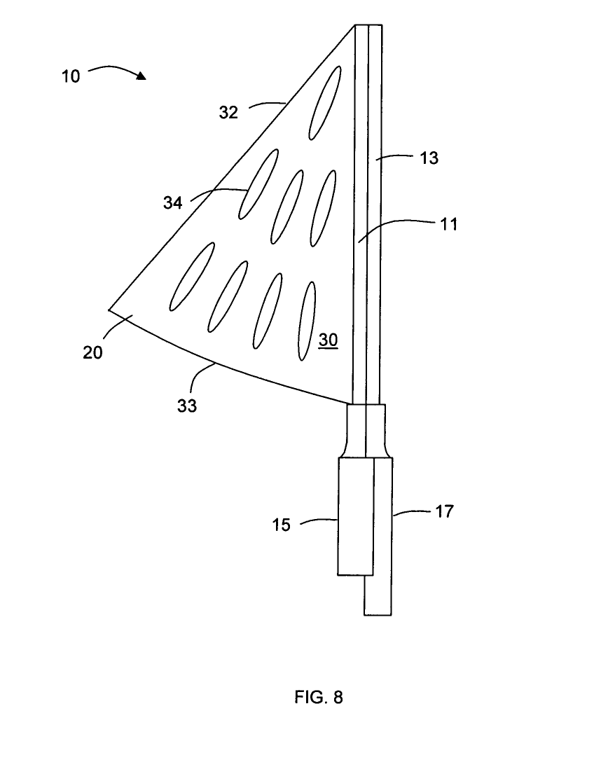

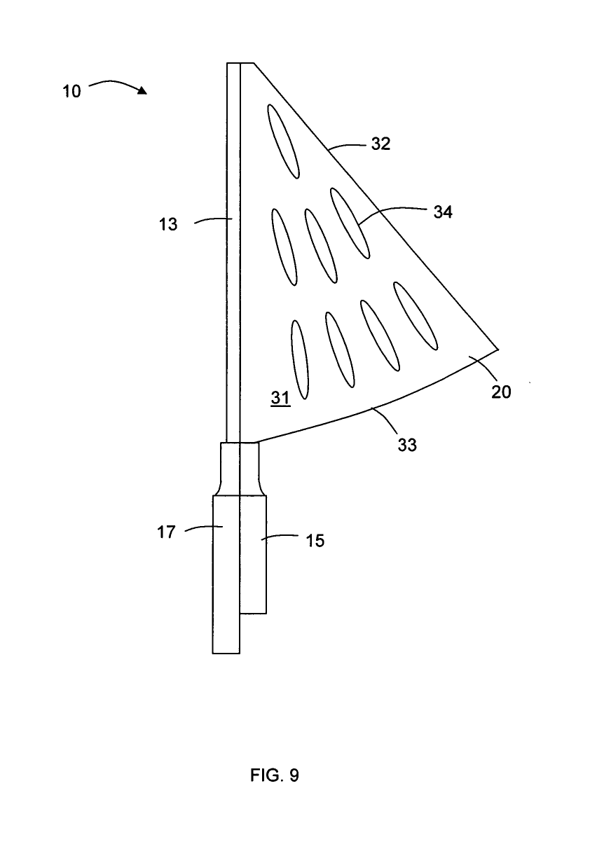

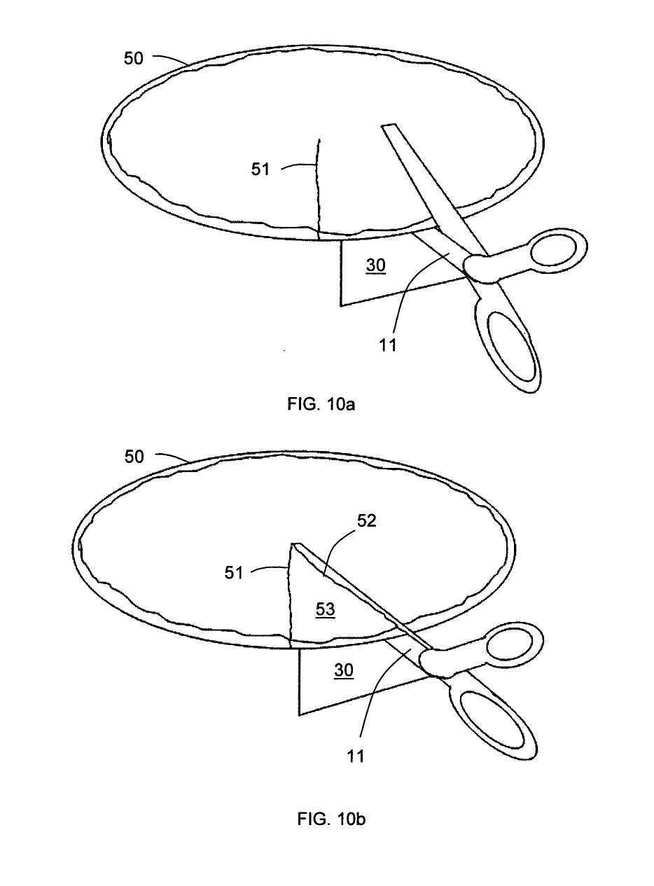

In an alternate embodiment, as shown in FIGS. 4b and 6-9, the spatula 20 is perpendicular to the second blade 13. That is, when the apparatus 10 is in position for cutting, the spatula 20 is substantially parallel to the surface on which the pizza sits. See FIG. 4b. The first blade 11 and spatula 20 are a single piece of PTFE-coated stainless steel. As illustrated in FIGS. 10a and 10b, to cut and serve a slice of pizza, the user inserts the first blade 11 and spatula 20 under the pizza 50 and makes a cut to the center of the pizza 50. If it is the first slice from the pizza 50, the user must make a second cut 52 at a distance from the first cut 51, about 4 inches in the preferred embodiment, to create a slice 53 that can be efficiently served on the spatula 20. Once the slice 53 is cut it rests on the spatula 20, and the user lifts and serves the slice 53 with the same hand he used to cut, without having to extract the apparatus 10 from contact with the pizza 53.

The materials used in the blades 11 and 13, fulcrum 19, and spatula 20 may be coated in a non-stick polymer to improve cutting effectiveness, such as fluorinated ethylene-polypropylene (“FEP”), perfluoroalkoxy polymer resin (“PFA”) or, preferably, polytetrafluoroethylene (“PTFE”).

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

I claim:

1. An apparatus for cutting and serving pizza, the apparatus comprising:
a. scissors comprising a first blade and a second blade connected to the first blade at a fulcrum; and
b. a spatula connected to the scissors.

2. The apparatus of claim 1 wherein the spatula is integral with the second blade and extends in substantially the same plane therefrom.

3. The apparatus of claim 1 wherein the spatula is integral with the first blade and substantially perpendicular thereto.

4. The apparatus of claim 1 wherein the spatula is triangular.

5. The apparatus of claim 1 wherein the spatula further comprises one or more slots.

6. The apparatus of claim 1 wherein, when the pizza rests on a horizontal surface, the spatula is in a plane that is substantially perpendicular to the horizontal surface when the apparatus is in position to cut the pizza.

7. The apparatus of claim 1 wherein, when the pizza rests on a horizontal surface, the spatula is in a plane that is substantially parallel to the horizontal surface when the apparatus is in position to cut the pizza.

8. The apparatus of claim 1 wherein the first and second blades are coated in a non-stick coating.

9. The apparatus of claim 1 wherein the spatula is coated in a non-stick coating.

10. The apparatus of claim 1 wherein the spatula is connected to the scissors with a hinge at the first blade or second blade.

11. An apparatus for cutting and serving a pizza positioned on a horizontal surface, the apparatus comprising:
a. scissors comprising:
i. a first handled blade comprising a stainless steel first blade and a polymer thumb handle connected to the first blade;
ii. a second handled blade connected to the first handled blade at a fulcrum, the second handled blade comprising a stainless steel second blade and a polymer finger handle connected to the second blade; and
iii. a pin connecting the first handled blade to the second handled blade at the fulcrum;
b. a triangular spatula connected to the second handled blade and extending out from the second handled blade in a direction that, when the apparatus is in position for cutting the pizza, is substantially perpendicular to the horizontal surface, the triangular spatula comprising:
iv. a leading edge;
v. a rear edge connected to the leading edge;
vi. a serving surface connected to the leading edge and facing away from the first blade; and
vii. a bottom surface connected to the leading edge and facing toward the first blade;
wherein the triangular spatula is stainless steel and is coated in polytetrafluoroethylene.
